(19) United States
(12) Patent Application Publication
(10) Pub. No.: US 2024/0086221 A1
(43) Pub. Date: Mar. 14, 2024

(54) HANDLING DEVICE CONFIGURATION CHANGES IN DISTRIBUTED NETWORK VERIFICATION APPLICATION

(71) Applicant: VMware, Inc., Palo Alto, CA (US)

(72) Inventors: Santhosh Prabhu Muraleedhara Prabhu, Urbana, IL (US); Kuan-Yen Chou, Champaign, IL (US); Aanand Nayyar, Palo Alto, CA (US); Giri Prashanth Subramanian, Cupertino, CA (US); Wenxuan Zhou, Santa Clara, CA (US); Philip Brighten Godfrey, Champaign, IL (US)

(21) Appl. No.: 17/945,837

(22) Filed: Sep. 15, 2022

Related U.S. Application Data
(60) Provisional application No. 63/404,725, filed on Sep. 8, 2022.

(51) Int. Cl. G06F 9/455

(52) U.S. Cl. CPC G06F 9/45558; G06F 2009/4557; G06F 2009/45595

(57) ABSTRACT

Some embodiments provide a method for an orchestration program instance assigned a particular network device in a network. Each network device of multiple network devices is assigned to a different orchestration program instance in a cluster. The method receives a notification message that a configuration for the particular network device has been modified. In response to the notification message, the method identifies a set of network correctness requirements to be evaluated for the network. The method sends a separate notification message for each identified network correctness requirement specifying that the particular network device configuration has been modified so that a set of evaluation program instances can re-evaluate any network correctness requirements dependent on the particular network device.

### BACKGROUND

Data plane verification is an important tool that allows network operators to continuously monitor their networks to ensure correctness. A data plane verification tool needs to regularly verify that machines that should be reachable are in fact reachable, that machines that should not be allowed to communicate are not able to do so, etc. Existing data plane verification tools typically rely on constructing a model of the network. However, for very large networks, such models can become unwieldy.

### BRIEF SUMMARY

Some embodiments provide a distributed network verification system for evaluating network correctness requirements. The distributed system of some embodiments executes on a cluster of data compute nodes (e.g., virtual machines (VMs), Java virtual machines (JVMs), containers, etc.). The distributed system includes numerous instances of micro-service programs that execute on the data compute nodes (DCNs) to evaluate a set of configured network correctness requirements. Some embodiments instantiate numerous separate evaluation program instances, each of which is tasked with (i) evaluating a set of one or more network correctness requirements and (ii) storing in the memory of its DCN one or more sets of network device data required to evaluate each of its assigned network correctness requirements. Thus, each of the program instances only stores data for a (generally relatively small) portion of the network in memory as opposed to being required to store data for the entire network.

As indicated, the purpose of the network verification system is to evaluate network correctness requirements. These network correctness requirements are configured by a user (e.g., a network administrator) and specify various conditions that must be met if the network is configured and operating correctly. For instance, an administrator might specify that a first set of DCNs in the network (e.g., application server VMs) should be able to communicate with a second set of DCNs (e.g., database server VMs) or that a third set of DCNs (e.g., relating to a payroll application) should not be reachable from various DCNs in the network. In addition to reachability conditions, administrators could specify that data messages addressed to a particular subnet must pass through a firewall before being delivered, that data messages with a particular destination address reach the DCN having that destination address, etc. The network verification system of some embodiments is tasked with analyzing a model of the network to verify each of these network correctness requirements and, if a particular network correctness requirement is not met, alerting the network administrator.

The network verification system of some embodiments is a distributed system that executes as numerous instances of micro-service programs in a cluster. In some embodiments, this cluster is a cluster of DCNs (e.g., VMs, containers, etc.) that operate on multiple host computers. The micro-service programs include a topology analysis program, numerous device data generation program instances (e.g., one per network device), numerous orchestration program instances (e.g., one per network device), and numerous evaluation program instances (e.g., one per network correctness requirement or group of network correctness requirements) in some embodiments. The programs in the cluster make use of (i) a distributed database that stores the network correctness requirements and results of verifying these network correctness requirements and (ii) a distributed file system that is used to store device data files generated by the device data generation program instances.

The program instances communicate with each other through messages (e.g., self-describing messages) that are delivered via the cluster framework in some embodiments. Each of these messages has an associated program instance that consumes the message and, in many cases, takes an action based on the receipt of the message. In some cases, a message being sent causes the cluster (e.g., a cluster manager) to instantiate a new instance of one of the programs in order to consume that message. In some embodiments, the topology analysis program sends messages for consumption by device data generation program instances, the device data generation program instances send messages for consumption by the orchestration program instances, and the orchestration program instances send messages for consumption by the evaluation program instances. The details of these specific messages will be described below.

In some embodiments, the cluster executes a single topology analysis program instance, while in other embodiments multiple topology analysis program instances execute to share responsibilities. The topology analysis program receives collected network device information from a set of pre-processing modules and performs various analyses and modifications on the network device information to produce coherent data. In some embodiments, a network controller, cluster of network controllers, or other network management entities collect network device information from the network devices and provide this network device information to the pre-processing modules.

The network devices can include physical devices (e.g., underlay switches and routers, physical middlebox appliances, etc.), software networking devices (e.g., virtual switches, virtual routers, distributed firewalls and other middleboxes, etc. that execute in virtualization software of host computers, gateway datapaths, etc.), logical networking constructs (e.g., logical switches and routers, logical firewall configurations, etc.). In some embodiments, any networking entity that processes data messages in the network is included as a network device in order to present a complete view of the network. The information collected, in some embodiments, provides all of the rules used by these networking devices to process data messages (including rule tables applied to data messages received at different interfaces, the relative priorities of these rules, etc.).

The topology analysis program instance receives the network device information and is responsible for eliminating inconsistencies, inferring missing information, and perform other operations to ensure that the network device information is consistent. For instance, if one device indicates that its network interface is down but a second device indicates that the interface is up, the topology analysis program resolves this issue (e.g., by modifying the information for the second device to indicate that the interface is down). The topology analysis program also connects links between devices when needed, in some embodiments. The topology analysis program outputs a coherent set of device files (e.g., one file per device) to the distributed file system. In addition, when the topology analysis program writes the file for a particular network device to the distributed file system, it sends a message to the cluster indicating that the particular network device is ready for further processing.

In some embodiments, the network device information is collected on a regular basis (e.g., every 5 minutes, every 30 minutes, etc.). The topology analysis program receives this data each time the information is collected in some embodiments, but does not rewrite the information for each network device every time. Once the topology analysis program has cleaned up the information for a network device, the program hashes that information (ignoring superficially-changing information such as timestamps) and compares that to previous hashes for the device. If no information has changed, the topology analysis program does not rewrite the device file or send out a message to the cluster.

The messages sent by the topology analysis program are consumed by the device data generation program instances. The first time a message is sent for a network device, the cluster (e.g., a cluster manager) instantiates a new device data generation program instance for that network device to consume the message. The device data generation program instances generate device data files in a unified format (as opposed to vendor-specific or protocol-specific information that is collected and output by the topology analysis program). This format, in some embodiments, expresses a set of rule tables that describe how the network device processes data messages. In some embodiments, each rule table describes a set of equivalence classes, which are groups of data messages that undergo the same processing at the rule table. Each equivalence class and the processing actions that are performed on those data messages (e.g., modifications to various header fields, dropping or blocking of the data messages, outputting the data messages to a specific interface, etc.) are grouped into flow nodes, which capture the various ways in which any possible data message is handled by each rule table. It should be noted that other embodiments use other formats for the rule tables, so long as that format captures how each rule table processes any data message received at its network device.

When a device data generation program instance receives a message (from the topology analysis program) that the network device for which it is responsible has been updated, the device data generation program instance retrieves the device information from the distributed file system and generates (or updates) the device data file for that network device. The device data generation program instances store their device data files to the distributed file system so that these data files are accessible to the evaluation program instances of the cluster. In general, a device data file exists in the distributed file system for each network device. The device data file for a particular device may be deleted if that device is removed from the network (based on analysis from the topology analyzer) or if the device data file is unused over a long enough period of time (indicating that the device has probably been removed from the network).

Each time a device data generation program instance updates the device data file for its network device, the device data generation program instance sends a message to a corresponding orchestration program instance in some embodiments. That is, some embodiments also instantiate one orchestration program instance per network device. The orchestration program instances operate as de-multiplexers in some embodiments, to notify each of the evaluation program instances when a device data file has been updated. Specifically, when an orchestration program instance for a particular network device receives a message from a corresponding device data generation program that the device data file for that particular network device has been updated, the orchestration program instance (i) retrieves a list of network correctness requirements from the distributed database for the cluster and (ii) sends one message per network correctness requirement to the evaluation program instances indicating that the evaluation program instance(s) handling that network correctness requirement may need to perform an updated verification of the network correctness requirement. Thus, if N network devices are updated and there are Mnetwork correctness requirements configured, the orchestrators send M×N messages. The evaluation program instances do not act on each of these messages, however, and only re-evaluate a particular network correctness requirement if that requirement depends on a newly-updated network device.

The evaluation program instances, in some embodiments, perform the actual evaluation of the network correctness requirements. To evaluate a particular network correctness requirement, an evaluation program instance initially identifies a set of data message properties associated with the requirement (e.g., a set of header fields and a starting point in the network). For instance, if data messages sent from a first VM to a second VM are required to reach that second VM, the header fields will include source and destination network addresses (e.g., IP and/or MAC addresses) associated with those VMs, possibly source and/or destination port numbers (depending on the specificity of the requirement), and/or other header field values. Some of the header fields may be wildcarded (e.g., port numbers if no specific ports/applications are specified by the requirement). In this example, the starting point in the network would be the ingress interface of the network device connected to the first VM (often a software forwarding element executing in the virtualization software of the host computer on which the first VM resides).

From this starting point, the evaluation program instance determines the path through a set of network devices of the network for the data message. This path may be a linear path for some data messages or may involve multiple branches (all of which should typically satisfy the network correctness requirement) in certain cases. For instance, a data message might match an ECMP rule specifying multiple different possible next hop routers. If the data message is required to reach a particular destination, all of the possible next hops should be verified as enabling the data message to reach that destination. For each network device along the path, the evaluation program instance retrieves the data file storing the data message processing rules (i.e., the rule tables) of the device and stores this device data in memory (e.g., the virtual or physical memory allotted to the evaluation program instance) in order for the evaluation program instance to use the in-memory device data in evaluating the network correctness requirement. Even for a complicated (e.g., multi-branched) path, the amount of network device data stored in the memory of any individual evaluation program instance for a single network correctness requirement will be relatively small compared to the amount of memory needed for the entire network map.

Specifically, to determine the path for a particular network correctness requirement, the evaluation program instance handling that requirement first identifies the initial network device that would process the data message and retrieves the device data file from the distributed file system for that initial network device (once a message is received that the device data file for that network device is stored in the file system). The evaluation program instance stores the device data file (i.e., the set of rule tables for the device) in memory (i.e., loads the rule tables into its memory) and uses the rule tables to determine a set of actions that would be applied to the data message by this initial network device. In some embodiments, this analysis requires analyzing multiple rule tables of the device, as the actions specified by a first rule table indicate for subsequent processing by another rule table (possibly after modifying one or more header fields).

The set of actions specified by the last rule table for a network device will often indicate that the data message would be sent to a particular interface of second network device (unless the actions specify to drop/block a data message or deliver the data message to its final destination). In this case, the evaluation program instance retrieves (from the distributed file system) the device data file for this second network device and loads that set of rule tables into memory. The evaluation program instance then uses the rule tables for this second network device to determine the set of actions that would be applied to the data message (as modified by the first network device). This process of retrieving and loading new device data files continues until a resolution would be reached for the data message (e.g., the data message would be dropped or delivered to a destination, whether the correct destination or not).

In some embodiments, if the device data file for an encountered device has not yet been generated, the evaluation program instance waits until a message is received from the orchestration program instance for that network device indicating that the file is now available. As mentioned, in some cases, the path through network devices (or even the path through rule tables within a network device) may branch. Some embodiments perform the evaluation depth-first, completing the analysis for one branch before moving onto the next branch.

As mentioned, the analysis of the network correctness requirements is performed by the evaluation program instances on a per-rule-table basis, but the retrieval of data files is handled on a per-device basis. Thus, to further save memory usage, some embodiments do not store entire device data files in memory, but rather only save the data for rule tables that are used to evaluate a particular network correctness requirement. The data for the other rule tables can be discarded. If other rule tables of a particular network device are needed when re-evaluating the requirement (e.g., because a previous network device has been updated, thereby causing the data message properties as received at the network device to be changed), then the device data file for that particular network device can be re-retrieved and the required rule table(s) stored in memory.

At an even finer-grained level, some embodiments only store portions of rule tables that are necessary for evaluating the network correctness requirement. For instance, a firewall rule table might have hundreds or thousands of entries for different destination network addresses, but only one applicable to the destination network address at issue for a particular network correctness requirement. In such cases, some embodiments discard the rest of the rule table and only store the particular rule or set of rules applicable to the data message(s) analyzed for its network correctness requirement.

An evaluation program instance evaluates its network correctness requirement for a first time as the necessary device files are stored in the distributed file system. The result of this evaluation is stored in the distributed database in some embodiments (indicating that the required condition has been met or that an error has been encountered). In some embodiments, if a condition is not met, the distributed network verification system raises an alert (e.g., to a network administrator).

In addition, anytime one of the devices used to verify a particular network correctness requirement is updated, the evaluation program instance handling that network correctness requirement retrieves the updated file, replaces the old version of the file in memory with the updated file, and re-evaluates the requirement. In some embodiments, the traversal of rule tables up to the updated device does not need to be re-evaluated, and the updated evaluation starts from that updated device. When an orchestration program instance sends out messages for each network correctness requirement indicating that a particular device has been updated, only the evaluation program instances managing requirements that rely on that device perform a re-evaluation; other evaluation program instances ignore the message.

Whereas the device data generation program instances and the orchestration program instances are instantiated on a per-device basis in some embodiments, the evaluation program instances may be instantiated in various configurations relative to the network correctness requirements. Some embodiments instantiate a single evaluation program instance for each network correctness requirement, while other embodiments group multiple network correctness requirements together for analysis by an individual evaluation program instance. Network correctness requirements may be grouped randomly or based on factors that make it more likely for the evaluation of the requirements to share the necessary network device data, so as to further save on memory usage. For instance, different network correctness requirements that relate to data messages sent by the same DCN are likely to share at least the initial device(s) in their evaluation paths. In addition, some network correctness requirements are divided up between multiple evaluation program instances. For instance, if a network correctness requirement relates to data messages sent from a group of DCNs (e.g., a group of 20 web servers), then these various paths can be traversed by multiple different evaluation program instances.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and the Drawings is needed. Moreover, the claimed subject matters are not to be limited by the illustrative details in the Summary, Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates a logical view of a network verification system of some embodiments.

FIG. 2 illustrates a set of host computers on which the distributed network verification application of some embodiments operates.

FIG. 3 conceptually illustrates a process of some embodiments for generating coherent network device information.

FIG. 4 conceptually illustrates a process of some embodiments for generating a device data file for a network device.

FIG. 5 conceptually illustrates the structure of rule tables in the device data files of some embodiments.

FIG. 6 conceptually illustrates a process of some embodiments for notifying evaluation program instances that a particular device data file has been updated so that the evaluation program can re-evaluate their network correctness requirements if needed.

FIG. 7 conceptually illustrates a process of some embodiments for evaluating a particular network correctness requirement.

FIG. 8 conceptually illustrates different sets of device information files loaded into the memories of different evaluation program instances when evaluating different network correctness requirements.

FIG. 9 conceptually illustrates two copies of a device data file loaded into memory by two different evaluation program instances.

FIG. 10 conceptually illustrates a rule table with numerous entries for different destination network addresses, specifying whether to drop or allow data messages having those addresses.

FIG. 11 conceptually illustrates a process of some embodiments for re-evaluating a network correctness requirement if needed.

FIG. 12 conceptually illustrates a process of some embodiments for assigning network correctness requirements to different evaluation program instances.

FIG. 13 conceptually illustrates an example network correctness requirement and the multiple data message paths required to evaluate the requirement.

FIG. 14 conceptually illustrates the grouping of four network correctness requirements (or sub-requirements after division) into two groups.

FIG. 15 conceptually illustrates the overlapping of device data files between simulated data message paths for two different network correctness requirements that are both evaluated by the same evaluation program instance.

FIG. 16 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a distributed network verification system for evaluating network correctness requirements. The distributed system of some embodiments executes on a cluster of data compute nodes (e.g., virtual machines (VMs), Java virtual machines (JVMs), containers, etc.). The distributed system includes numerous instances of micro-service programs that execute on the data compute nodes (DCNs) to evaluate a set of configured network correctness requirements. Some embodiments instantiate numerous separate evaluation program instances, each of which is tasked with (i) evaluating a set of one or more network correctness requirements and (ii) storing in the memory of its DCN one or more sets of network device data required to evaluate each of its assigned network correctness requirements. Thus, each of the program instances only stores data for a (generally relatively small) portion of the network in memory as opposed to being required to store data for the entire network.

As indicated, the purpose of the network verification system is to evaluate network correctness requirements. These network correctness requirements are configured by a user (e.g., a network administrator) and specify various conditions that must be met if the network is configured and operating correctly. For instance, an administrator might specify that a first set of DCNs in the network (e.g., application server VMs) should be able to communicate with a second set of DCNs (e.g., database server VMs) or that a third set of DCNs (e.g., relating to a payroll application) should not be reachable from various DCNs in the network. In addition to reachability conditions, administrators could specify that data messages addressed to a particular subnet must pass through a firewall before being delivered, that data messages with a particular destination address reach the DCN having that destination address, etc. The network verification system of some embodiments is tasked with analyzing a model of the network to verify each of these network correctness requirements and, if a particular network correctness requirement is not met, alerting the network administrator.

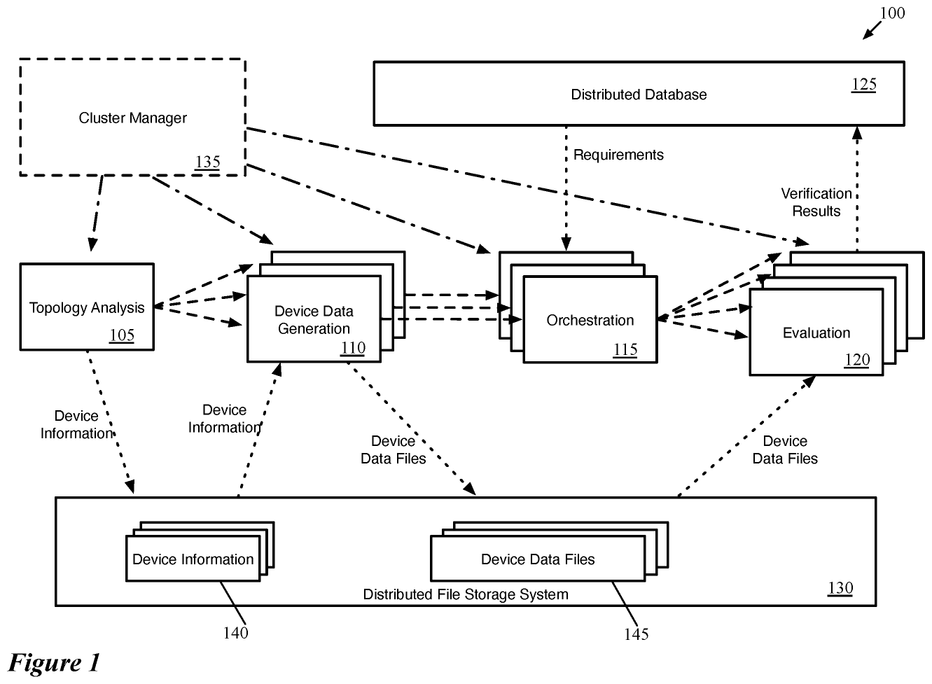

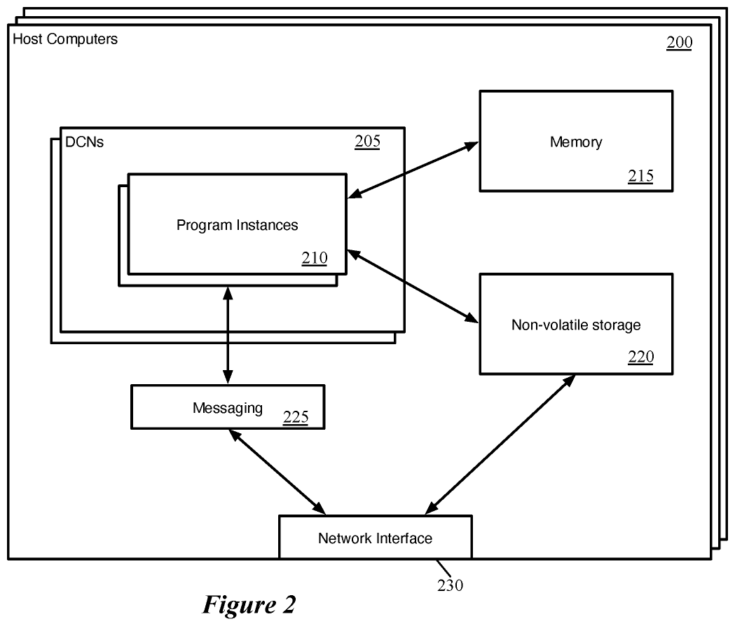

FIG. 1 conceptually illustrates a logical view of a network verification system 100 of some embodiments. This network verification system is a distributed system that executes as numerous instances of micro-service programs in a cluster. In some embodiments, as shown more fully in FIG. 2, this cluster is a cluster of DCNs (e.g., VMs, containers, etc.) that operate on multiple host computers. Specifically, in some embodiments the various micro-service programs execute on a cluster of Java virtual machine (JVM) instances that form an Apache Samza grid. The logical view of the network verification system 100 does not show the physical computers or the DCNs, but rather illustrates the various micro-service programs that are instantiated on these DCNs.

As shown, in some embodiments these micro-service programs include a topology analysis program 105, numerous device data generation program instances 110, numerous orchestration program instances 115, and numerous evaluation program instances 120. The programs 105-120 in the cluster also make use of (i) a distributed database 125 that stores the network correctness requirements and results of verifying these network correctness requirements and (ii) a distributed file system 130 (e.g., a Hadoop distributed file system (HDFS)) that is used to store device data files generated by the device data generation program instances. In addition, in some embodiments the distributed application is managed by a cluster manager 135 or other entity.

The program instances 105-120 communicate with each other through messages (e.g., self-describing messages) that are delivered via the cluster framework in some embodiments. Each of these messages has an associated program instance that consumes the message and, in many cases, takes an action based on the receipt of the message. In some cases, a message being sent causes the cluster manager 135 or another entity to instantiate a new instance of one of the programs in order to consume that message. In some embodiments, the topology analysis program 105 sends messages for consumption by device data generation program instances 110, the device data generation program instances 110 send messages for consumption by the orchestration program instances 115, and the orchestration program instances 115 send messages for consumption by the evaluation program instances 120. The details of these specific messages will be described below.

In some embodiments, the cluster executes a single topology analysis program 105 (as shown), while in other embodiments multiple topology analysis program instances execute to share responsibilities. The topology analysis program 105 receives collected network device information from a set of pre-processing modules (that collect the network device information from the network) and performs various analyses and modifications on the network device information to produce coherent data, which the topology analysis program 105 stores to the distributed file storage system as a set of device information files 140. When the device information file 140 for a particular network device is prepared and saved to the distributed file system 130, the topology analysis program 105 also sends a message for consumption by one of the device data generation program instances 110.

The cluster, in some embodiments, includes one device data generation program instance 110 for each network device (i.e., for a verification system 100 that monitors a large network, there could be hundreds or even thousands of device data generation program instances 110). If the topology analysis program 105 sends a message for a particular network device that does not yet have a corresponding device data generation program instance 110, then the cluster manager 135 or other entity instantiates a new device data generation program instance 110 for that network device. Each device data generation program instance 110 retrieves the device information file for its corresponding network device and generates a device data file 145 in a unified format for the device. Whereas the device information files 140 can vary in format from one network device type (e.g., switch, router, firewall, etc.) or vendor to the next, the device data files 145 are all in the same format (e.g., a collection of linked rule tables). These device data files 145 are for use by the distributed network verification system 100 to evaluate the network correctness requirements in some embodiments.

The cluster also includes one orchestration program instance 115 for each network device in some embodiments. When a device data generation program instance 110 completes (or updates) a device data file 145 and stores that to the distributed file storage 130, the device data generation program instance 110 sends a message to the cluster for consumption by the corresponding orchestration program instance 115 (for the same network device). The orchestration program instances 115 operate as de-multiplexers in some embodiments, to notify each of the evaluation program instances 120 when a device data file 145 has been updated. Specifically, when an orchestration program instance 115 for a particular network device receives a message from a corresponding device data generation program instance 110 that the device data file 145 for that particular network device has been updated, the orchestration program instance (i) retrieves a list of network correctness requirements from the distributed database 125 and (ii) sends one message per network correctness requirement to the evaluation program instances 120 indicating that the evaluation program instance(s) 120 handling that network correctness requirement may need to perform an updated verification of the network correctness requirement.

The evaluation program instances 120, in some embodiments, perform the actual evaluation of the network correctness requirements. Whereas the device data generation program instances 110 and the orchestration program instances 115 are instantiated on a per-device basis in some embodiments, the evaluation program instances 120 may be instantiated in various configurations relative to the network correctness requirements. In some embodiments the cluster manager 135 or another entity instantiates a single evaluation program instance 120 for each network correctness requirement, while in other embodiments the cluster manager 135 (or other entity) groups multiple network correctness requirements together for analysis by an individual evaluation program instance 120. In addition, some embodiments divide certain network correctness requirements (e.g., those that require verification for multiple independent data message paths) among multiple evaluation program instances 120.

To evaluate a particular network correctness requirement, an evaluation program instance 120 initially identifies a set of data message properties associated with the requirement (e.g., a set of header fields and a starting point in the network). From this starting point, the evaluation program instance 120 determines the path through a set of network devices of the network for the data message. This path may be a linear path for some data messages or may involve multiple branches (all of which should typically satisfy the network correctness requirement) in certain cases. For each network device along the path, the evaluation program instance retrieves the device data file 145 storing the data message processing rules (i.e., the rule tables) of the network device and loads this network device data file 145 into memory (e.g., the virtual or physical memory allotted to the evaluation program instance 120) so that the evaluation program instance can use the in-memory device data (rule tables) to evaluate the network correctness requirement. Even for a complicated (e.g., multi-branched) path, the amount of network device data stored in the memory of any individual evaluation program instance for a single network correctness requirement will be relatively small compared to the amount of memory needed for the entire network map.

The cluster manager 135, in some embodiments, is responsible for managing the various program instances 105-120. In some embodiments, the cluster manager 135 instantiates program instances as needed. For instance, when the topology analysis program 105 generates information for a new network device, the cluster manager 135 in some embodiments instantiates the device data generation program instance 110 and orchestration program instance 115 for the new network device. In addition, in some embodiments, the cluster manager 135 is responsible for assigning network correction requirements to the different evaluation program instances 120.

FIG. 2 illustrates a set of host computers 200 on which the distributed network verification application operates. In order to alleviate the memory burden on any individual computing device, some embodiments distribute the application cluster across numerous host computers 200. These host computers 200 may operate within the network being monitored (e.g., making use of the networking devices being monitored in order to facilitate communicate between the program instances) or on a separate network in different embodiments.

On each host computer, a set of DCNs 205 (e.g., JVMs) operate, within which the various program instances 210 (e.g., the program instances 105-120 of the distributed application) execute. In some embodiments, multiple DCNs 205 for the distributed application may execute on a single host computer 200, so long as memory usage limits are observed. Different embodiments may place memory usage limits on individual program instances (specifically on the evaluation program instances), on DCNs, and/or on combined usage across all the DCNs of a host computer.

In addition, in some embodiments multiple program instances 210 can execute on each DCN 205. For instance, it may be advantageous for the device data generation program instance and the orchestration program instance for the same network device to execute on the same DCN 205 (as the former sends messages only to the latter). Some embodiments limit the number of evaluation program instances executing on one DCN (or across all of the DCNs on one host computer 200) because these program instances use by far the most memory loading the necessary device data files.

Each host computer also includes memory 215 and non-volatile storage 220. The memory 215, in some embodiments, is primarily used by the evaluation program instances to store device data files used in evaluating the network correctness requirements assigned to those evaluation program instances (though can also be used by the other program instances in the course of their operation). The non-volatile storage 220 is used for the distributed file storage system that stores the device information and the device data files as well as the distributed database, in some embodiments. The memory 215 and non-volatile storage 220 are accessible by the program instances 210 (e.g., through the use of virtualization software on the host computers, which is not shown).

In some embodiments, the program instances communicate with each other through messaging functionality 225. This messaging functionality 225, in some embodiments, may include software networking (e.g., within the virtualization software) as well as cluster-specific messaging functionality for propagating the self-describing messages of the cluster. This cluster-specific messaging functionality may execute within the DCNs as well in some embodiments. This messaging (and the distributed file system and/or database) also make use of the network interface(s) 230 of the host computers as well, in order for information to be communicated across the host computers 200.

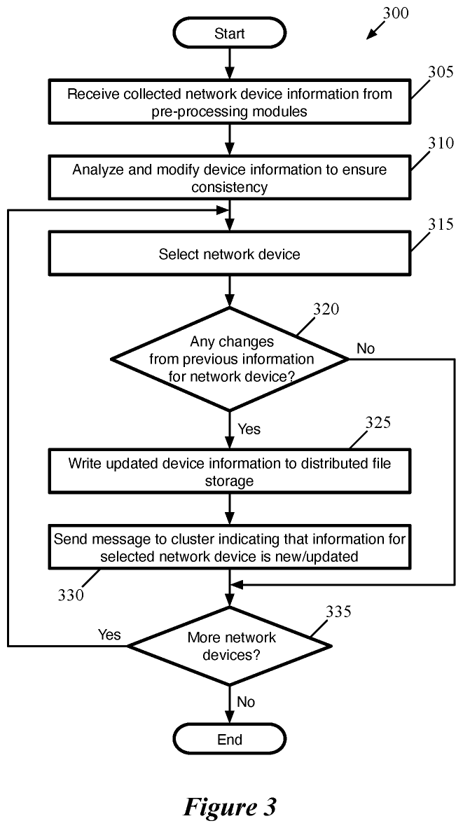

The operation of the different program instances within the distributed network verification system (e.g., the program instances 105-120) of some embodiments will now be described. FIG. 3 conceptually illustrates a process 300 of some embodiments for generating coherent network device information. The process 300, in some embodiments, is performed by a topology analysis program instance of a distributed network verification system (e.g., the program instance 105 shown in FIG. 1). In some embodiments, the topology analysis program performs this process 300 (or a similar process) regularly (e.g., each time network information is collected for the network devices of the network monitored by the network verification application).

As shown, the process 300 begins by receiving (at 305) collected network device information from a set of pre-processing modules. The network devices can include physical devices (e.g., underlay switches and routers, physical middlebox appliances, etc.), software networking devices (e.g., virtual switches, virtual routers, distributed firewalls and other middleboxes, etc. that execute in virtualization software of host computers, gateway datapaths, etc.), logical networking constructs (e.g., logical switches and routers, logical firewall configurations, etc.). In some embodiments, any networking entity that processes data messages in the network is included as a network device in order to present a complete view of the network. The information collected, in some embodiments, provides all of the rules used by these networking devices to process data messages (including rule tables applied to data messages received at different interfaces, the relative priorities of these rules, etc.).

In some embodiments, the device information is collected from different locations for different types of devices. For physical devices (e.g., underlay switches and routers), some embodiments communicate directly with the devices to retrieve their forwarding tables and other configuration information. For managed network devices (e.g., software routers and switches managed by a network control system, any physical devices managed by such a system, etc.), some embodiments receive the configuration from the network control system. Other embodiments communicate with these physical and virtual devices so as to receive the current realized configuration rather than the desired configuration from the network control system. For logical network devices, some embodiments retrieve this information from the network control system.

Next, the process 300 analyzes and modifies (at 310) the device information to ensure consistency. The topology analysis program instance is responsible for eliminating inconsistencies, inferring missing information, and performing other operations to ensure that the network device information is consistent. For instance, if one network device indicates that its network interface is down but a second network device indicates that the interface is up, the topology analysis program resolves this issue (e.g., by modifying the information for the second device to indicate that the interface is down). The topology analysis program also connects links between devices when needed, in some embodiments.

The topology analysis program generates a coherent set of device information files (e.g., one file per network device) in some embodiments. These device information files, in some embodiments, include the device information received from the pre-processing modules, but are ensured to be consistent with each other based on the processing of the topology analysis program.

Thus, the process 300 next selects (at 315) one of the network devices. It should be understood that the process 300 is a conceptual process. While the operations 315-330 are shown as being performed serially for each of the network devices, in some embodiments the topology analysis program performs these operations in parallel for numerous network devices (i.e., checking for new device information and outputting the device information files for many network devices at once).

Next, the process 300 determines (at 320) whether the device information for the selected device has changed from the previous information saved to the distributed file storage. As described, in some embodiments the network device information is collected on a regular basis (e.g., every 5 minutes, every 30 minutes, etc.). The topology analysis program receives this data each time the information is collected in some embodiments, but rewriting the information to storage and notifying the device data generation program instance for the network device each time information is collected would be highly inefficient. Thus, the topology analysis program only performs these actions if the device information has changed. In some embodiments, once the topology analysis program has cleaned up the information for a network device (i.e., ensured its consistency with the rest of the network devices), the program hashes a set of the device information. The set of device information that is hashed excludes information that changes regularly but does not affect the configuration (e.g., timestamps), but includes all of the configuration data. The hash is then compared to a previous saved hash for the network device (e.g., from the last time the device changed). If no such saved hash exists, then the device is a new device, and the device information should be saved.

If the device information is modified for the selected network device (or the network device is new), the process 300 writes (at 325) the updated (or new) device information to the distributed file storage. The process 300 also sends (at 330) a message to the cluster indicating that information for the selected network device is updated (or new). The message specifies the network device in some embodiments, with the cluster mechanism being responsible for either (i) delivering the message to an existing device data generation program instance or (ii) instantiating a new device data generation program instance if no such program instance yet exists (i.e., if the network device information is new).

The process 300 then determines (at 330) whether any additional network devices remain for analysis (though, as noted above, in some embodiments many such network devices are processed in parallel). If additional network devices remain for analysis, the process 300 returns to 315 to select the next network device and determine whether the device information for that network device is updated. Once all of the network devices have been processed, the process 300 ends.

The messages sent by the topology analysis program are consumed by the device data generation program instances. The first time a message is sent for a network device, the cluster (e.g., a cluster manager) instantiates a new device data generation program instance for that network device to consume the message. The device data generation program instances generate device data files in a unified format (as opposed to protocol-specific or vendor-specific information that is collected and output by the topology analysis program).

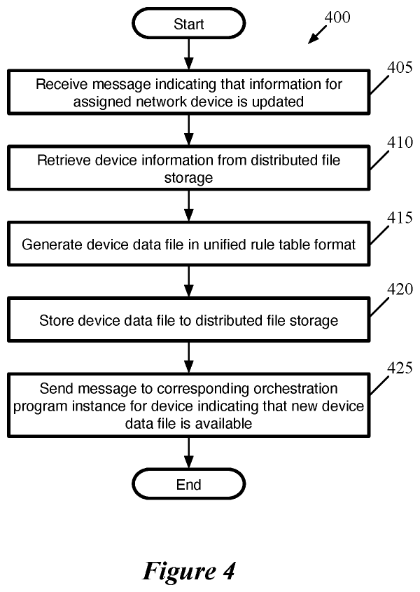

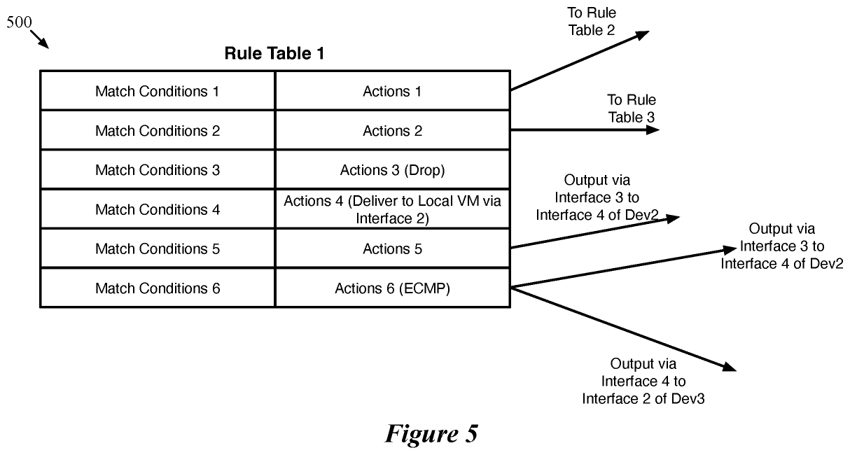

FIG. 4 conceptually illustrates a process 400 of some embodiments for generating a device data file for a network device. In some embodiments, the process 400 is performed at least once by each device data generation program instance. The process 400 is performed when a device data generation program instance is initially instantiated for a new network device, as well as each time the topology analysis program indicates that the device information for the network device has been updated. The process 400 will be described in part by reference to FIG. 5, which conceptually illustrates the structure of rule tables in the device data files of some embodiments.

As shown, the process 400 begins by receiving (at 405) a message indicating that information for an assigned network device has been updated (or is newly created). As mentioned, these messages are sent by the topology analysis program to the cluster each time the device information is updated for a network device. The cluster messaging framework is responsible for delivering the message to the correct device data generation program instance for the updated network device.

The process 400 then retrieves (at 410) the device information for the assigned network device from the distributed file storage. In some embodiments, this device information is a file in a non-uniform format that provides configuration information about the network device. For instance, different types of physical network devices (e.g., switches, routers, firewalls, and/or other types of middleboxes) may use different formats for their device information while a network controller may format the configuration information for software and/or logical network devices. In addition, the physical network devices use vendor-specific formats in some embodiments. The device configuration information, in some embodiments, indicates the various forwarding tables and other data message processing rules, in one format or another.

Next, the process 400 uses this device information to generate (at 415) a device data file in a unified rule table format. That is, whereas the device information from the topology analysis program can have any specific format, all of the device data files generated by the various different device data generation program instances have the same format so that they can be used for evaluation by other program instances (i.e., by the evaluation program instances) of the distributed network verification application. This unified format, in some embodiments, expresses a set of rule tables that describe how the network device processes data messages. In some embodiments, each rule table describes a set of equivalence classes, which are groups of data messages that undergo the same processing at the rule table. Each equivalence class and the processing actions that are performed on those data messages (e.g., modifications to various header fields, dropping or blocking of the data messages, outputting the data messages to a specific interface, etc.) are grouped into flow nodes, which capture the various ways in which any possible data message is handled by each rule table.

FIG. 5 conceptually illustrates an example rule table 500 in the unified format of some embodiments. In some embodiments, each rule table is structured as a set of match-action entries. Each set of match conditions describes a set of data message properties defining a set of data messages. These data message properties can be specific values for specific header fields (e.g., a specific destination network address or destination port number), ranges of values for such header fields (e.g., a particular destination network address subnet), other properties (e.g., the physical ingress port at which a data message was received), and/or other properties.

Each entry in the rule table 500 also specifies a set of actions to apply to simulated data messages having those properties. In some embodiments, the actions can modify data message properties (e.g., MAC address rewrites performed by a router) and also specify a next operation to take when simulating data message processing. These operations can include proceeding to another rule table, as in the first two entries that specify to link to two different rule tables. For example, a software forwarding might have a rule table for a logical router that links to multiple different logical switch tables depending on the destination network address subnet. In addition to links to other rule tables within the same device, these operations can include links to other devices. For instance, the fifth entry specifies to output via a specific interface of the current device, which links to another specific interface of another device. Some entries can have multiple possible operations, which cause path splits when simulating the processing of a data message. The sixth entry in the rule table 500 is an equal-cost multi-path (ECMP) routing entry that specifies two possible paths data messages could take. While an actual data message would of course only be sent along one of these paths, network verification needs to analyze both paths. The network verification operations performed by the verification program instances are described in more detail below. The specified operations can also include final actions that end the data message processing simulation, such as dropping the data message (as in the third entry) or delivering the data message to its final destination (as in the fourth entry). It should be noted that other embodiments use other formats for the rule tables, so long as that format captures how each rule table processes any data message received at its network device.

Returning to FIG. 4, the process 400 stores (at 420) the generated device data file to the distributed file storage. If a previous device data file existed in the storage for the network device, that file is replaced so that only one device data file exists for the network device. In general, one device data file exists in the distributed file system for each network device. The device data file for a particular device may be deleted if that device is removed from the network (based on analysis from the topology analysis program) or if the device data file is unused over a long enough period of time (indicating that the device has probably been removed from the network).

The process 400 also sends (at 425) a message to the corresponding orchestration program instance for the network device to indicate that the new device data file is available, then ends. In some embodiments, this is a self-describing message that is sent to the cluster messaging framework for consumption by the orchestration program instance in the same way that the messages from the topology analysis program are for consumption by the device data generation program instances.

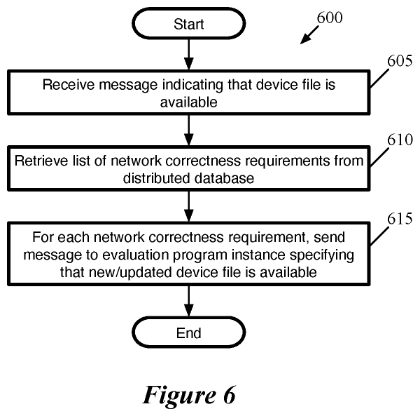

As mentioned, the orchestration program instances operate as de-multiplexers in some embodiments, to notify each of the evaluation program instances when a device data file has been updated. FIG. 6 conceptually illustrates a process 600 of some embodiments for notifying evaluation program instances that a particular device data file has been updated so that the evaluation program can re-evaluate their network correctness requirements if needed. The process 600, in some embodiments, is performed by an orchestration program instance for a particular network device. In some embodiments, the process 600 is performed at least once by each orchestration program instance. Like with the device data generation program instances, the orchestration program instances perform the process 600 when the device data file is first created as well as each time the device data file is updated.

As shown, the process 600 begins by receiving (at 605) a message indicating that the device data file for the assigned network device is available (i.e., is newly created or updated). As described, these messages are sent by the device data generation program instances to the cluster each time the device information is updated for a network device. The cluster messaging framework is responsible for delivering the message to the correct orchestration program instance for the updated network device.

The process 600 then retrieves (at 610) a list of network correctness requirements from the distributed database of the cluster. The orchestration program instance, in some embodiments, retrieves this list each time the device data file is updated to ensure that the list of network correctness requirements is up to date. In some embodiments, the network administrator may regularly add, remove, or modify requirements, and these changes are reflected in the distributed database.

Finally, for each network correctness requirement, the process 600 sends (at 615) a message to the evaluation program instance that evaluates the network correctness requirement specifying that the new or updated device data file is available. This message indicates that the evaluation program instance(s) handling that network correctness requirement may need to perform an updated verification of the network correctness requirement. In some embodiments, if N network devices are updated and there are M network correctness requirements configured, the orchestrators send M×N messages. The evaluation program instances do not act on each of these messages, however, and only re-evaluate a particular network correctness requirement if that requirement depends on a newly-updated network device.

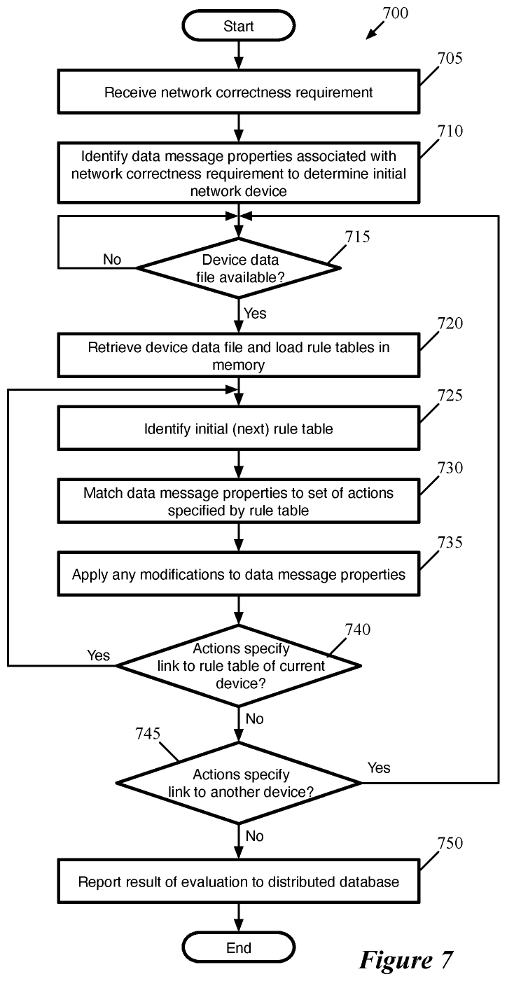

The evaluation program instances perform the actual evaluation of the network correctness requirements in some embodiments. FIG. 7 conceptually illustrates a process 700 of some embodiments for evaluating a particular network correctness requirement. The process 700 is performed by different evaluation program instances in a cluster for different network correctness requirements (and/or different subsets of a multi-path network correctness requirement, in certain cases described below). In some embodiments, an evaluation program instance performs the process 700 once when the network correctness requirement is assigned to that program instance, and then performs a similar process when network devices along the path it determines for the network correctness requirement evaluation are updated.

As shown, the process 700 begins by receiving (at 705) a network correctness requirement. As described in more detail below, in some embodiments a cluster manager or other entity (e.g., a management program of the distributed network verification application) assigns the network correctness requirements to different evaluation program instances based on a variety of factors.

In some embodiments, network correctness requirements are configured by a user (e.g., a network administrator) and specify various conditions that must be met if the network is configured and operating correctly. For instance, an administrator might specify that a first set of DCNs in the network (e.g., web server VMs) should be able to communicate with a second set of DCNs (e.g., database server VMs) or that a third set of DCNs (e.g., relating to a payroll application) should not be reachable from various DCNs in the network. In addition to reachability conditions, administrators could specify that data messages addressed to a particular subnet must pass through a firewall before being delivered, that data messages with a particular destination address reach the DCN having that destination address, etc.

Next, the process 700 identifies (at 705) a set of data message properties associated with the assigned network correctness requirement to determine an initial network device. In some embodiments, the set of data message properties includes (i) a set of header fields of a simulated data message used to evaluate the network correctness requirement and (ii) a starting point in the network for the simulated data message. It should be noted that the process 700 only describes the evaluation of a single simulated data message path. If a network correctness requirement specifies, for example, reachability between first and second groups of VMs, then that will necessitate evaluation of multiple data message path simulations. However, each of these paths is evaluated separately in some embodiments, so that the process 700 is applied to each of these simulated paths.

The set of header fields are determined based on the characteristics and specificity of the network correctness requirement to evaluate. For instance, if data messages sent from a first VM to a second VM are required to reach that second VM, the header fields will include source and destination addresses (e.g., IP and/or MAC addresses) associated with those VMs, but with certain other fields (e.g., port numbers) wildcarded. On the other hand, if the requirement is more specific and applies only to data messages for a specific application, source and/or destination port numbers may be specifically assigned for the simulated data message properties.

The starting point of the network, in some embodiments, includes both an initial network device and an interface at which that network device receives the data message, so that an initial rule table to apply can be determined. In the example of a first VM sending a data message to the second VM, the starting point in the network would be the ingress interface of the network device connected to the first VM (often a software forwarding element executing in the virtualization software of the host computer on which the first VM resides).

From this starting point, the evaluation program instance determines the path through a set of network devices of the network for the data message. This path may be a linear path for some data messages or may involve multiple branches (all of which should typically satisfy the network correctness requirement) in certain cases. For instance, a data message might match an ECMP rule specifying multiple different possible next hop routers. If the data message is required to reach a particular destination, all of the possible next hops should be verified as enabling the data message to reach that destination. It should be noted that the operations 715-745, described below, relate to the evaluation of a single-branch network correctness requirement path. For multi-branch paths, some embodiments perform a depth-first traversal. That is, when a path branches, one of the branches is selected and the operations are performed for that path to reach the end of the path. Then the evaluation program instance returns to the branching point and evaluates the next branch, and so on until all of the branches have been evaluated. If previous branch points were encountered, the evaluation program instance continues its depth-first traversal until all possible paths have been evaluated for compliance with the network correctness requirement.

For each network device along the path, the evaluation program instance retrieves the data file storing the data message processing rules (i.e., the rule tables) of the device and stores this device data in memory (e.g., the virtual or physical memory allotted to the evaluation program instance) in order for the evaluation program instance to use the in-memory device data in evaluating the network correctness requirement. Even for a complicated (e.g., multi-branched) path, the amount of network device data stored in the memory of any individual evaluation program instance for a single network correctness requirement will be relatively small compared to the amount of memory needed for the entire network map.

More specifically, as shown in FIG. 7, after identifying the data message properties of the simulated data message for evaluating the network correctness requirement, the process 700 determines (at 715) whether the device data file is available in the distributed file storage for the initial network device along the simulated path. The device data file for a particular network device is only available if the topology analysis module has sent a message specifying that the device information has been made available and the device data generation program instance has generated the file. Initially, at the time the distributed network verification has just been setup, then the device data file might not be available yet. In some embodiments, the verification program instance searches the distributed file storage for a device data file for the particular network device. In other embodiments, the verification program instance waits until a message is received from the orchestration program instance for the particular network device indicating that the device data file is now available. If the device data file is not yet available, the process 700 enters a wait state until the file becomes available.

Once the device data file is available, the process 700 retrieves (at 720) the device data file and loads the rule tables in memory. As mentioned, each device data file includes a set of one or more rule tables. The verification program instance loads these rule tables into its memory (e.g., the physical or virtual memory of the DCN on which the verification program instance executes) so that the program instance can evaluate the rule tables to simulate processing of the data message. As will be described below, in some embodiments all of the rule tables are loaded but some (those that are not used) may be discarded from memory after the network correctness requirement evaluation is complete (or after the analysis is complete for the specific network device).

The process 700 then identifies (at 725) the initial rule table (or the next rule table in subsequent passes through operations 725-745). The initial rule table for a network device, in some embodiments, is based on the ingress interface at which the simulated data message is received at the network device. Subsequent rule tables are identified based on the links specified by evaluation of previous rule tables. As shown in FIG. 5, an entry in a rule table may specify a link to another rule table that should be evaluated next.

Next, the process 700 matches (at 730) the data message properties to a set of actions specified by the rule table. As described above, the data message properties include a set of header fields as well as other data. The entries in the rule table match on these properties, and the evaluation program instance identifies the matching entry for the simulated data message. The matching entry also specifies a set of actions to perform.

With the matching entry identified, the process 700 applies (at 735) any modifications to the data message properties specified by the set of actions. The set of actions can include such modifications as well as an indication of the next operation to perform. The modifications can include specifying a new ingress interface (e.g., if the simulated data message is to be linked to another device) or modifying the header fields. For instance, when a data message is routed, the router typically performs MAC address rewrites that modify the source and destination MAC addresses of the data message. The actions could also specify adding an encapsulation header to the simulated data message, decrementing the time to live (TTL) field, or other such modifications.

As noted, the set of actions also specifies a next operation. Thus, the process 700 determines (at 740) whether the actions specify a link to another rule table of the current device. It should be noted that, in certain cases, a set of actions can also specify to re-evaluate the same rule table after the modifications have been made to the data message properties. If the actions specify a link to another rule table, the process 700 proceeds to 725 to identify the next rule table and evaluate that rule table.

If a link to another rule table of the same device is not specified, then the actions specify either a link to another network device (e.g., outputting the data message via a particular interface of the current network device that is connected to another network device) or an action that ends the data message path simulation. If the actions do not specify a link to another rule table of the same device, the process 700 determines (at 745) whether the actions specify a link to another device. It should be noted that the process 700 is a conceptual process, and that the evaluation program instance of some embodiments does not necessarily make the decisions recited in operations 740 and 745 separately. Rather, depending on whether the set of actions specifies a link to another rule table of the same device, a link to another device, or a path-ending action, the evaluation program instance takes the specified action.

If the actions specify a link to another device, the process 700 returns to 715 to determine whether the device data file for this next device is available. Thus, the evaluation program instance traverses the rule tables in one device until a rule table entry specifies a link to another device. This process is repeated, as the device files for the traversed devices are loaded into the evaluation program instance memory, until a path-ending action is reached.

If the actions do not specify either a link to another rule table of the same device or a link to another device, then they specify a path-ending action. These path-ending actions can include dropping the data message, sending the data message out of the managed network (at which point the operations applied to the data message can no longer be simulated), or delivering the data message to its destination (e.g., a DCN).

In this case, the process 700 reports (at 750) the result of the evaluation to the distributed database. In some embodiments, this operation entails determining whether the network correctness requirement is validated or contradicted by the specified path-ending action. For instance, if a data message that is supposed to reach a first VM will be dropped or delivered to a different destination, then the network correctness requirement is contradicted. On the other hand, if the data message would be delivered to the first VM, the network correctness requirement is validated. The evaluation program instance stores this result to the distributed database so that another module (e.g., a manager of the cluster and/or distributed application) can take an action based on the result. For instance, if the network correctness requirement is not met, some embodiments raise an alert to a network administrator.

By traversing only the necessary network devices and loading these files into memory, the amount of network device data stored in the memory of any individual evaluation program instance for a single network correctness requirement is relatively small compared to the amount of memory that would be needed to store the entire network map. These files then remain in memory, at least until a device is updated and the evaluation program instance re-evaluates the network correctness requirement.

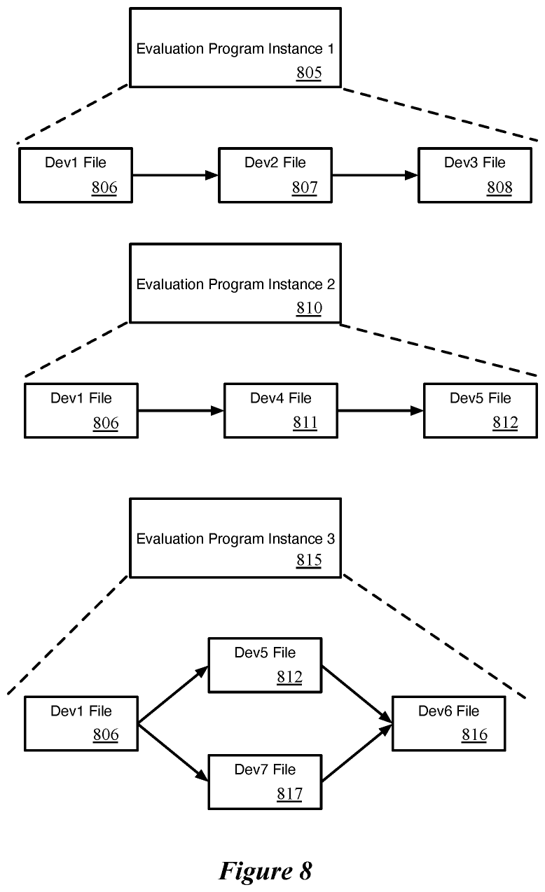

FIG. 8 conceptually illustrates different sets of device information files loaded into the memories of different evaluation program instances when evaluating different network correctness requirements. Specifically, a first evaluation program instance 805 loads three device data files 806-808 into its memory, a second evaluation program instance 810 loads three device data files 806, 8011, and 812 into its memory, and a third evaluation program instance 815 loads four device data files 806, 812, 816, and 817 into its memory.

The overall network could contain thousands of network devices and thus a full map of the network would require thousands (or possibly millions) of rule tables of these devices, but each of the evaluation program instances 805, 810, and 815 only needs to load three or four of the device data files. Although some of the files (e.g., the device data file 805) are loaded into the memory of multiple different evaluation program instances, the savings on a per-instance basis are substantial. For a multi-branch path such as that evaluated by the third evaluation program instance 815, any device file on multiple paths (e.g., the device file 816) only needs to be loaded into memory once.

As described by reference to FIG. 7, the analysis of the network correctness requirements is performed by the evaluation program instances on a per-rule-table basis, but the retrieval of data files is handled on a per-device basis. Thus, to further save memory usage, some embodiments do not store entire device data files in memory, but rather only save the data for rule tables that are used to evaluate a particular network correctness requirement. The data for the other rule tables can be discarded.

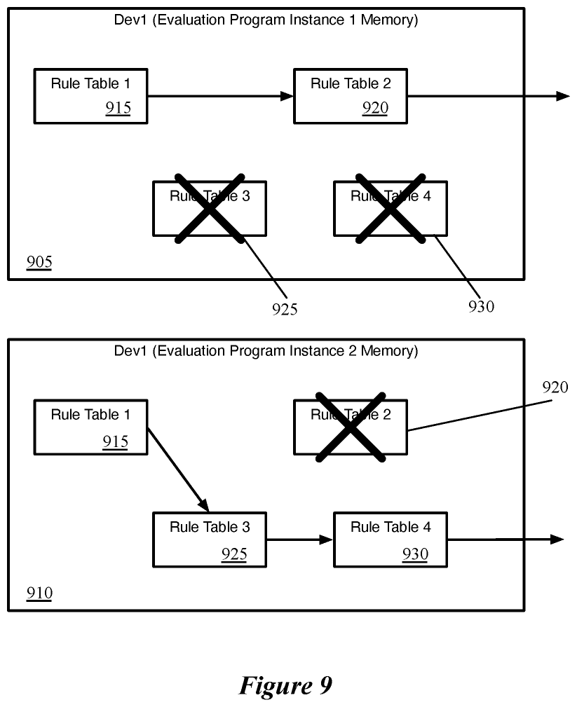

FIG. 9 conceptually illustrates two copies 905 and 910 of a device data file loaded into memory by two different evaluation program instances. Each of these copies of the device data file includes four rule tables 915-930 (noting that many device data files will include many more rule tables than shown in this example). The first evaluation program instance, in evaluating its network correctness requirement, traverses the first two rule tables 915 and 920, but does not use rule tables 925 and 930. The second evaluation program instance, in evaluating its own network correctness requirement, traverses three rule tables 915, 925, and 930, but does not use rule table 920. As such, the first evaluation program instance discards from memory the rule tables 925 and 930, while the second evaluation program instance discards from memory the rule table 920.

If other rule tables of a particular network device are needed when re-evaluating a network correctness requirement (e.g., because a previous network device has been updated, thereby causing the data message properties as received at the network device to be changed), then the device data file for that particular network device can be re-retrieved and the newly required rule table(s) stored in memory.

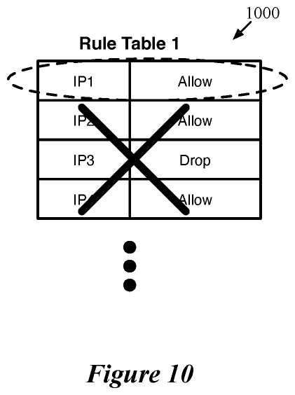

At an even finer-grained level, some embodiments only store portions of rule tables that are necessary for evaluating the network correctness requirement. For instance, FIG. 10 conceptually illustrates a rule table 1000 (e.g., a firewall rule table) with numerous entries for different destination network addresses, specifying whether to drop or allow data messages having those addresses. Such a rule table might have hundreds or thousands of entries for different destination network addresses, but only one applicable to the destination network address at issue for a particular network correctness requirement. As shown in this example, the rule matched during the network correctness requirement evaluation process (the first rule for IPI) is kept in memory while the other rules are removed as they are not applicable to the evaluation process.

As described above by reference to FIG. 7, evaluation program instances evaluate their respective network correctness requirements for the first time as the necessary device files are stored in the distributed file system and store the result of this evaluation in the distributed database in some embodiments (indicating that the required condition has been met or that an error has been encountered). In addition, anytime one of the devices used to verify a particular network correctness requirement is updated, the evaluation program instance handling that network correctness requirement retrieves the updated file, replaces the old version of the file in memory with the updated file, and re-evaluates the requirement.

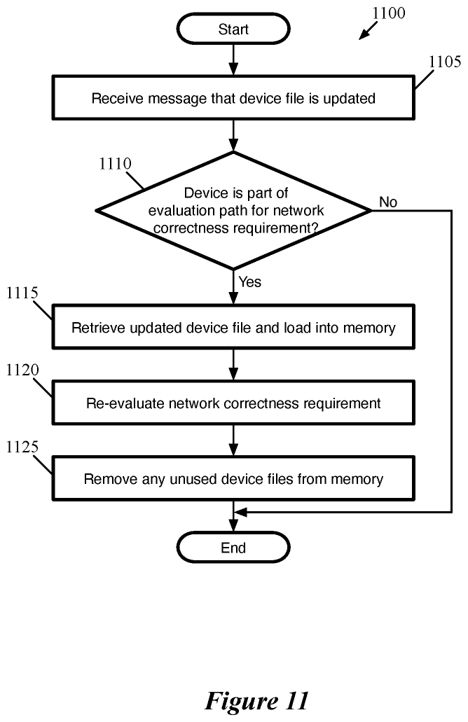

FIG. 11 conceptually illustrates a process 1100 of some embodiments for re-evaluating a network correctness requirement if needed. The process 1100 is performed by each of the evaluation program instances in a distributed network verification application of some embodiments each time one of the orchestration program instances sends a message specifying that a device data file has been updated by the corresponding device data generation program instance. In some embodiments, an evaluation program instance that evaluates multiple network verification requirements performs the process 1100 multiple times (once for each network verification requirement) upon receiving such messages.

As shown, the process 1100 begins by receiving (at 1105) a message that a particular device data file is updated. As noted, the orchestration program instances of some embodiments send out messages for each network correctness requirement when their respective device data file is updated. In other embodiments, the orchestration program instance sends out one message for each operational evaluation program instance.

In response to the receipt of this message, the process 1100 determines (at 1110) whether the particular network device is part of the evaluation path for the network correctness requirement. As mentioned, this process is performed for each of the network correctness requirements evaluated by an evaluation program instance in some embodiments. A network device is part of the evaluation path if any of the rule tables in the device data file for that network device are stored in memory for evaluation of the network correctness requirement (i.e., if any of the rule tables of that network device are traversed during the course of evaluating the network correctness requirement. If the particular network device is not part of the evaluation path, then updates to that device's rule tables are not of concern and the process 1100 ends.

However, if the particular network device is part of the evaluation path for the network correctness requirement, then the requirement needs to be re-evaluated as the changes could affect the processing of the simulated data message used to evaluate the requirement. As such, the process 1100 retrieves (at 1115) the updated device data file and loads this device data file into memory (replacing the previous device data file).

The process 1100 then re-evaluates (at 1120) the network correctness requirement. In some embodiments, the evaluation program instance performs the process 700 or a similar process to retrieve device files and load these files into memory. In some embodiments, the evaluation process begins from the modified network device; any rule table traversal up to that point can be assumed to be the same. Thus, the re-evaluation starts with the first rule table of the modified network device and proceeds from that point. In some cases, the modifications to the particular network device will not affect the evaluation at all (e.g., if the modifications only change rule tables that are not used when evaluating the network correctness requirement). If the rule tables of other devices that are needed for re-evaluation are already loaded in memory, then the evaluation program instance does not need to retrieve these device data files again. However, in some cases the modifications to the particular network device configuration will affect (i) which device data files are needed and/or (ii) which rule tables from existing device data files are needed to evaluate the network correctness requirement. In either case, the necessary device data files are retrieved from the distributed file storage.

Finally, the process 1100 removes (at #1125) any unused device data files from memory, then ends. In some cases, during re-evaluation, the evaluation program instance traverses a different path through the network devices such that device data files previously used for evaluating the network correctness requirement are no longer needed. For instance, if a VM has migrated from one host computer to another, then the configuration for devices to send data messages to that VM will change and the path for data message sent to that VM will traverse different network devices. As another example, a firewall rule might be changed so that certain data messages are dropped rather than allowed. Device data files for some of the network devices in the prior path (e.g., a software switch at the previous host computer that no longer hosts the VM, or any network devices after the firewall that now drops the data message) will no longer be needed, so the evaluation program evicts these device data files from memory so as to not waste memory space on unneeded device data.

Whereas the device data generation program instances and the orchestration program instances are instantiated on a per-device basis in some embodiments, the evaluation program instances may be instantiated in various configurations relative to the network correctness requirements. Some embodiments instantiate a single evaluation program instance for each network correctness requirement, while other embodiments group multiple network correctness requirements together for analysis by an individual evaluation program instance.

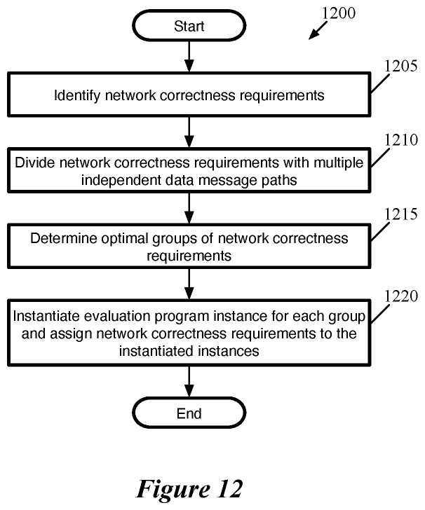

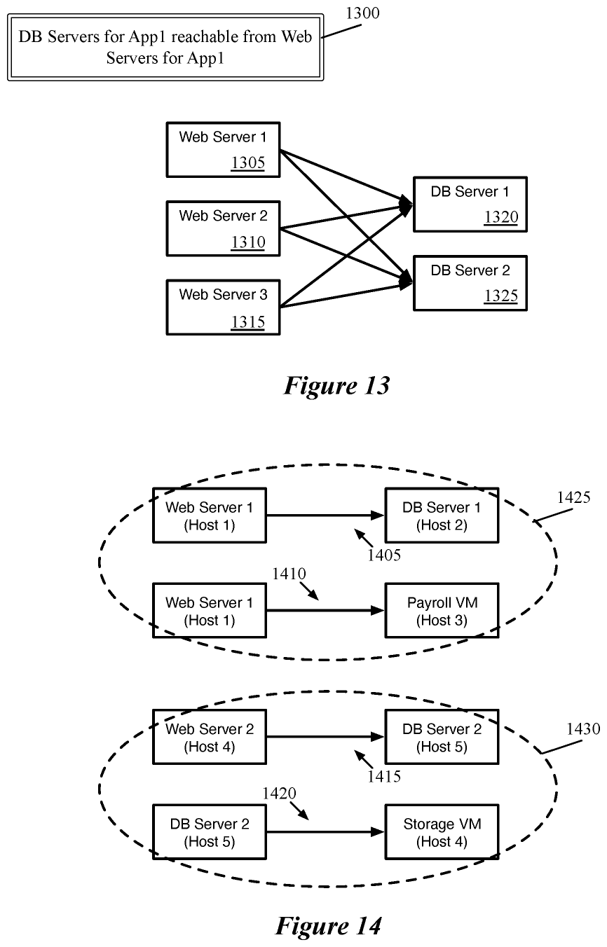

FIG. 12 conceptually illustrates a process 1200 of some embodiments for assigning network correctness requirements to different evaluation program instances. The process 1200 is performed by a cluster manager or other module of the distributed network verification application that is responsible for managing the instantiation of the various micro-service programs. The process 1200 will be described in part by reference to FIGS. 13-15.

As shown, the process 1200 begins by identifying (at 1205) network correctness requirements that the network verification application is responsible for monitoring. As described above, these network correctness requirements are configured by a user (e.g., a network administrator) in some embodiments and specify various conditions that must be met if the network is configured and operating correctly. These conditions can indicate that one DCN (or group of DCNs) should be able to communicate (or should be prevented from communicating) with another DCN (or group of DCNs), that data messages having a particular destination address are delivered to a particular VM, that certain data messages are processed by a particular middlebox (e.g., a specific firewall), etc.

Next, the process 1200 divides (at 1210) any network correctness requirements with multiple independent data message paths. Verifying some network correctness requirements requires evaluation of data messages either from a group of DCNs or to a group of DCNs (or both), which can create multiple data message paths that are analyzed independently (but which all need to be analyzed to verify reachability). It should be noted that this does not refer to multi-branch data message paths, as these are not known until the evaluation program instance traverses the data message path.

FIG. 13 conceptually illustrates an example network correctness requirement 1300 and the multiple data message paths required to evaluate the requirement. As shown, the network correctness requirement 1300 specifies that database servers for a particular application (App1) are reachable from the web servers for that application. In this example, the application includes three web servers 1305-1315 and two database servers 1320 and 1325. As a result, six separate independent data message paths need to be evaluated to determine whether the network is functioning correctly (as any of these paths failing would indicate a problem). That is, the path from web server 1305 to database server 1320, the path from web server 1305 to database server 1325, the path from web server 1310 to database server 1320, the path from web server 1310 to database server 1325, the path from web server 1315 to database server 1320, and the path from web server 1315 to database server 1325 all need to be evaluated. There is no reason that these independent paths should necessarily be evaluated together, so they can be treated as separate network correctness requirements for assignment to evaluation program instances.

The process 1200 then determines (at 1215) optimal groups of network correctness requirements (treating network correctness requirements divided into multiple independent paths as separate requirements). The process also instantiates (at 1220) an evaluation program instance for each of these groups and assigns the network correctness requirement groups to the instantiated instances, then ends. Some embodiments group network correctness requirements randomly, but other embodiments base the grouping on factors that increase the likelihood that the evaluation of the network correctness requirements will use overlapping network device data so as to save on memory usage.

FIG. 14 conceptually illustrates the grouping of four network correctness requirements 1405-1420 (or sub-requirements after division) into two groups 1425 and 1430. As shown, the first requirement 1405 requires simulation of a data message path (e.g., for testing reachability) between a first web server on a first host and a first database server on a second host. The second requirement 1410 requires simulation of a data message path between the first web server and a payroll VM on a third host. The third requirement 1415 requires simulation of a data message path between a second web server on a fourth host and a second database server on a fifth host. Lastly, the fourth requirement 1420 requires simulation of a data message path between the second database server and a storage VM on the fourth host.

The first two requirements 1405 and 1410 both require simulation of data messages originating from the same web server, and therefore at least the initial rule tables that the data message path traverses are likely to be the same. The latter two requirements 1415 and 1420 require simulation of data messages between the same two host computers and thus, even though the two paths are in the opposite direction, will likely have a substantial overlap of network devices (and probably some overlap of rule tables). As such, the first two requirements 1405 and 1410 are assigned to one group 1425 while the latter two requirements 1415 and 1420 are assigned to a second group 1430.

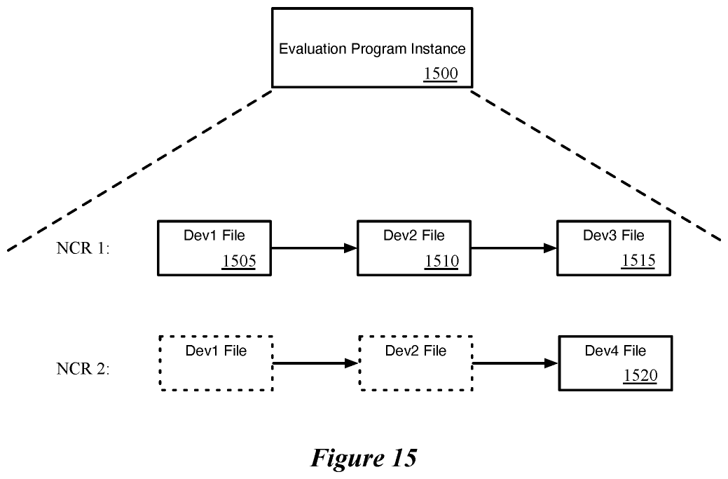

These optimized assignments enable evaluation program instances to share device data files between multiple network correctness requirement paths. FIG. 15 conceptually illustrates the overlapping of device data files between simulated data message paths for two different network correctness requirements that are both evaluated by the same evaluation program instance 1500. The simulated data message path for the first network correctness requirement traverses three network devices, for which the evaluation program instance 1500 loads the device data files 1505-1515. When simulating the data message path for the second network correctness requirement, the first two network devices are the same as for the first network correctness requirement, and thus the evaluation program instance uses the copies of device data files 1505 and 1510 already stored in memory. The third network device in this case is a different network device that is not used for the simulated data message path of the first network correctness requirement, and thus the evaluation program instance retrieves and loads the corresponding device data file 1520 into its memory.

This example shows the case in which entire device data files are stored in the memory of the evaluation program instance 1500, but it should be understood that the same concept of reusing data between different simulated data message paths can be expanded to individual rule tables. It should be noted that doing so can require more retrieval of the device data files from the distributed file storage, however. If a particular rule table of the first device file 1505 is discarded during the evaluation of the first network correctness requirement, then the evaluation program instance 1500 would have to retrieve that device file 1505 a second time if that particular rule table is needed when evaluating the second network correctness requirement.

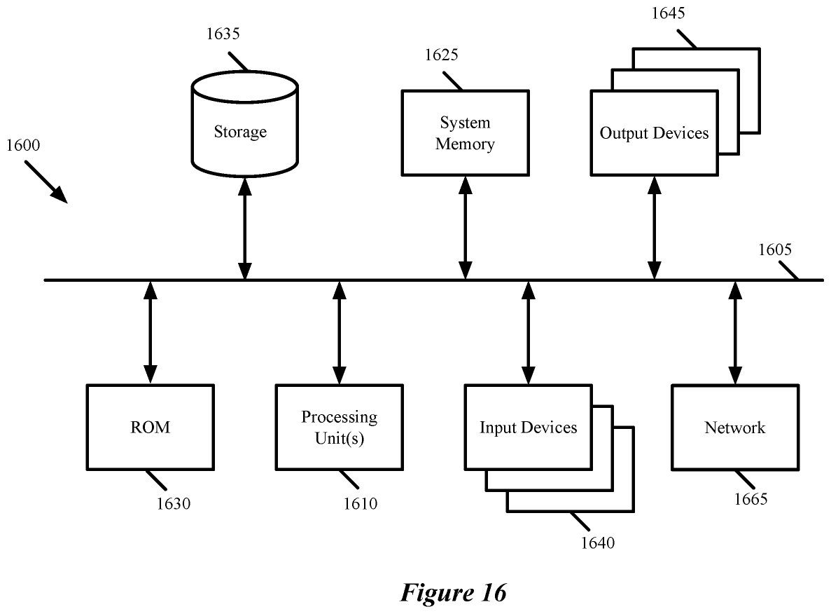

FIG. 16 conceptually illustrates an electronic system 1600 with which some embodiments of the invention are implemented. The electronic system 1600 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 1600 includes a bus 1605, processing unit(s) 1610, a system memory 1625, a read-only memory 1630, a permanent storage device 1635, input devices 1640, and output devices 1645.

The bus 1605 collectively represents all system, peripheral, and chipset buses that communicatively connect the numerous internal devices of the electronic system 1600. For instance, the bus 1605 communicatively connects the processing unit(s) 1610 with the read-only memory 1630, the system memory 1625, and the permanent storage device 1635.

From these various memory units, the processing unit(s) 1610 retrieve instructions to execute and data to process in order to execute the processes of the invention. The processing unit(s) may be a single processor or a multi-core processor in different embodiments.

The read-only-memory (ROM) 1630 stores static data and instructions that are needed by the processing unit(s) 1610 and other modules of the electronic system. The permanent storage device 1635, on the other hand, is a read-and-write memory device. This device is a non-volatile memory unit that stores instructions and data even when the electronic system 1600 is off. Some embodiments of the invention use a mass-storage device (such as a magnetic or optical disk and its corresponding disk drive) as the permanent storage device 1635.

Other embodiments use a removable storage device (such as a floppy disk, flash drive, etc.) as the permanent storage device. Like the permanent storage device 1635, the system memory 1625 is a read-and-write memory device. However, unlike storage device 1635, the system memory is a volatile read-and-write memory, such a random-access memory. The system memory stores some of the instructions and data that the processor needs at runtime. In some embodiments, the invention's processes are stored in the system memory 1625, the permanent storage device 1635, and/or the read-only memory 1630. From these various memory units, the processing unit(s) 1610 retrieve instructions to execute and data to process in order to execute the processes of some embodiments.

The bus 1605 also connects to the input and output devices 1640 and 1645. The input devices enable the user to communicate information and select commands to the electronic system. The input devices 1640 include alphanumeric keyboards and pointing devices (also called “cursor control devices”). The output devices 1645 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 16, bus 1605 also couples electronic system 1600 to a network 1665 through a network adapter (not shown). In this manner, the computer can be a part of a network of computers (such as a local area network (“LAN”), a wide area network (“WAN”), or an Intranet, or a network of networks, such as the Internet. Any or all components of electronic system 1600 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures (including FIGS. 3, 4, 6, 7, 11, and 12) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

1. A method for evaluating a network, the method comprising:
at an orchestration program instance assigned a particular network device in the network, wherein each network device of a plurality of network devices is assigned to a different orchestration program instance in a cluster:
receiving a notification message that a configuration for the particular network device has been modified;
in response to the notification message, identifying a set of network correctness requirements to be evaluated for the network; and
sending a separate notification message for each identified network correctness requirement specifying that the particular network device configuration has been modified so that a set of evaluation program instances can re-evaluate any network correctness requirements dependent on the particular network device.

2. The method of claim 1, wherein the notification message is sent by a particular device data generation program instance executing in the cluster.

3. The method of claim 2, wherein the cluster includes, for each network device, a device data generation program instance and an orchestration program instance.

4. The method of claim 2, wherein the particular device data generation program instance (i) is the device data generation program instance for the particular network device and (ii) stores a network device data file for the particular network device to a distributed file system that is shared by the program instances executing in the cluster.

5. The method of claim 4, wherein the evaluation program instances that require for the particular network device to evaluate network correctness requirements retrieve the network device data file for the particular network device from the distributed file system.

6. The method of claim 1, wherein identifying the set of network correctness requirements comprises retrieving a set of configured network correctness requirements from a database shared by program instances executing in the cluster.

7. The method of claim 6, wherein the set of evaluation program instances store results of evaluating the network correctness requirements to the database.

8. The method of claim 1, wherein the orchestration program instance is a first orchestration program instance, the particular network device is a first network device, the notification message is a first notification message, and the set of evaluation program instances is a first set of evaluation program instances, wherein a second orchestration instance assigned a second network device in the network:
receives a second notification message that a configuration for the second network device has been modified;
in response to the second notification message, identifies the set of network correctness requirements to be evaluated for the network; and
sends a separate notification message for each identified network correctness requirement specifying that the second network device configuration has been modified so that a second set of evaluation program instances can re-evaluate any network correctness requirements dependent on the second network device.

9. The method of claim 8, wherein at least one evaluation program instance re-evaluates a network correctness requirement based on the updates to the first and second network devices.

10. The method of claim 1, wherein the notification message is a self-describing message.

11. A non-transitory machine-readable medium storing an orchestration program instance for execution by at least one processing unit, the orchestration program instance assigned a particular network device in a network, wherein each network device of a plurality of network devices is assigned to a different orchestration program instance in a cluster, the orchestration program instance comprising sets of instructions for:
receiving a notification message that a configuration for the particular network device has been modified;
in response to the notification message, identifying a set of network correctness requirements to be evaluated for the network; and
sending a separate notification message for each identified network correctness requirement specifying that the particular network device configuration has been modified so that a set of evaluation program instances can re-evaluate any network correctness requirements dependent on the particular network device.

12. The non-transitory machine-readable medium of claim 11, wherein the notification message is sent by a particular device data generation program instance executing in the cluster.

13. The non-transitory machine-readable medium of claim 12, wherein the cluster includes, for each network device, a device data generation program instance and an orchestration program instance.

14. The non-transitory machine-readable medium of claim 12, wherein the particular device data generation program instance (i) is the device data generation program instance for the particular network device and (ii) stores a network device data file for the particular network device to a distributed file system that is shared by the program instances executing in the cluster.

15. The non-transitory machine-readable medium of claim 14, wherein the evaluation program instances that require for the particular network device to evaluate network correctness requirements retrieve the network device data file for the particular network device from the distributed file system.

16. The non-transitory machine-readable medium of claim 11, wherein the set of instructions for identifying the set of network correctness requirements comprises a set of instructions for retrieving a set of configured network correctness requirements from a database shared by program instances executing in the cluster.

17. The non-transitory machine-readable medium of claim 16, wherein the set of evaluation program instances store results of evaluating the network correctness requirements to the database.

18. The non-transitory machine-readable medium of claim 11, wherein the orchestration program instance is a first orchestration program instance, the particular network device is a first network device, the notification message is a first notification message, and the set of evaluation program instances is a first set of evaluation program instances, wherein a second orchestration instance assigned a second network device in the network:
receives a second notification message that a configuration for the second network device has been modified;
in response to the second notification message, identifies the set of network correctness requirements to be evaluated for the network; and
sends a separate notification message for each identified network correctness requirement specifying that the second network device configuration has been modified so that a second set of evaluation program instances can re-evaluate any network correctness requirements dependent on the second network device.

19. The non-transitory machine-readable medium of claim 18, wherein at least one evaluation program instance re-evaluates a network correctness requirement based on the updates to the first and second network devices.

20. The non-transitory machine-readable medium of claim 11, wherein the notification message is a self-describing message.
